(19) United States
(12) Patent Application Publication
(10) Pub. No.: US 2011/0219405 A1
(43) Pub. Date: Sep. 8, 2011

(54) SYSTEM, METHOD AND APPARATUS FOR INTEGRATING SOCIAL FUNCTIONS INTO A DEVICE

(75) Inventor: Matthew Blake McRae, Laguna Beach, CA (US)

(73) Assignee: VIZIO, INC., Irvine, CA (US)

(21) Appl. No.: 12/716,294

(22) Filed: Mar. 3, 2010

(51) Int. Cl. H04N 5/445; H04N 7/173; H04N 5/44

(52) U.S. Cl. 725/39; 725/110; 348/734; 348/E05.096

(57) ABSTRACT

An application for a television interfacing to a social network includes an interface to the social network relating to a program or activity of the user. For example, if the user is watching a sporting event, using their remote control, the user easily informs other social network subscribers or groups of subscribers of the sporting event, in case they are unaware that the sporting event is being televised. With a simple command initiative, the receiving subscriber changes to the recommended content/program.

### FIELD

This invention relates to the field of social networking and more particularly to a system for socially interacting on a display screen of a device such as a television.

### BACKGROUND

Social networks such as MySpace and FaceBook are well known for use by computer and cell-phone users. Early social networks provided a dating service whereby a user would register and create a profile containing a posting. In this, they would describe themselves, their likes, dislikes, hobbies, work, etc. Once created, the posting is advertised to others looking for, perhaps, a date.

Later, such networks evolved to concentrate on needs other than dating. Web sites the likes of MySpace and FaceBook appeal to the social needs of people, providing a canvas on which members write about themselves, post pictures and the like.

Web sites such as Linkedin and Plaxo provide online business networking similar to other social networks. Such networks provide secure access and features that enhances business relationship networking. For example, once you are invited to become a friend (or buddy) to another member and accept, you have the ability to keep in contact with that member even when they change jobs, move, etc. Furthermore, if friends of your friend allow, you will be able to network with people that you haven't met, but trust because of your buddy.

Social networking has hereto for been practiced primarily by users of computer systems such as personal computers, notebooks and even cellular phones. In such, the networking session is somewhat private to the user of the computer system (e.g., the user is one-on-one with the computer system) and these systems have privacy and security already in place.

Recently, certain devices such as televisions have progressed to encompass increased computational and display capabilities. Typical high-definition televisions currently have far better display and processing power than many personal computers. Furthermore, these devices are being networked to for example, provide enhanced content from the Internet. With such capability, there is now room for social networking features.

What is needed is a system that will provide an extension of social networking to a device such as a television.

### SUMMARY

A device, such as a television, interfaces to a social network and provides an interface to the social network relating to a program or activity of the user. For example, if the user is watching a sporting event, using their remote control, the user easily informs other social network subscribers of the sporting event, in case they are unaware that the sporting event is being televised, etc.

In one embodiment, a social network system is disclosed including a network and a plurality of televisions, each of the televisions has a processor and each processor is interfaced to the network. A social network system includes a server that is also interfaced to the network. There is software for registering each of the televisions with the social network and software for signaling a first television of the televisions to initiate a social network function, responsive to the signaling, the first television of the televisions sends an information packet over the network to the server where software on the server distributes a request packet from the social network to one or more of the televisions over the network. At the one or more of the televisions, software receives the request packet, displays information from the request packet and changes content shown on the one or more of the televisions based on viewer approval.

In another embodiment, a method of providing social network features to a television is disclosed including, providing a network and a plurality of televisions, each of the televisions having a processor, each processor interfaced to the network and providing a social network system that has a server, the server also interfaced to the network. Next, registering each of the televisions with the social network. Signaling a first television of the televisions to initiate a social network function and responsive to the signaling, the first television of the televisions sending an information packet over the network to the server where the server distributes a request packet to one or more of the televisions over the network and at the one or more of the televisions, the request packet is received, information from the request packet is displayed and a content shown on the one or more of the televisions is changed based on viewer approval.

In another embodiment, a system for providing social network features to a television is disclosed including, a network, a first television and a second television. Each of the televisions has a processor and each processor is interfaced to the network. The system includes a social network system that has a server also interfaced to the network. Software running on each of the processors registers each of the televisions with the social network and software running on the processor of the first television initiates a social network function responsive to a command from a remote control associated with the first television by sending an information packet over the network to the server where software running on the server receives the information packet and, responsive to the information packet, distributes a request packet over the network to one or more televisions, including the second television. Software running on the processor of the second television receives the request packet, displays information from the request packet, reads a viewer's command from a remote control associated with the second television, and changes a content shown on the second televisions based on approval of the viewer.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a block diagram of a social network.

FIG. 2 illustrates a plan view of a typical television showing a first content being viewed by an originating user.

FIG. 3 illustrates a plan view of a typical television showing the first content and a pop-up selection being viewed by the originating user.

FIG. 4 illustrates a plan view of a typical television showing the first content and a highlighted selection being viewed by the originating user.

FIG. 5 illustrates a plan view of a typical television showing a second content being viewed by a receiving user.

FIG. 6 illustrates a plan view of a typical television showing the second content and a pop-up message being viewed by the receiving user.

FIG. 7 illustrates a plan view of a typical television showing the first content now being viewed by the receiving user.

FIG. 8 illustrates a plan view of a typical television showing the second content still being viewed by the receiving user.

FIG. 9 illustrates a first flow chart operating on a processor within the typical television.

FIG. 10 illustrates a second flow chart operating on the processor within the typical television.

FIG. 11 illustrates a first flow chart operating on a processor of a social network.

FIG. 12 illustrates a third flow chart operating on the processor within the typical television.

FIG. 13 illustrates a fourth flow chart operating on the processor within the typical television.

FIG. 14 illustrates a block diagram of a typical television system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

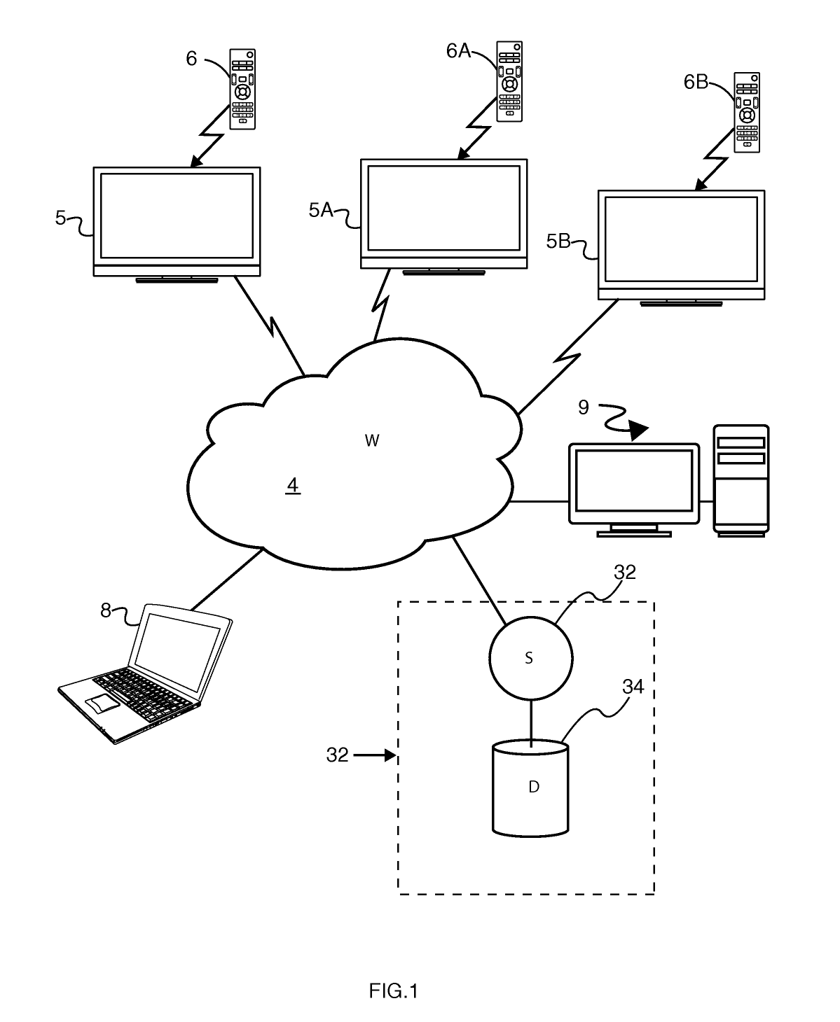

Referring to FIG. 1, a block diagram of a social network will be described. In this, multiple devices 5/5A/5B/8/9 are connected to a network 4 such as the Internet 4. Some of the devices are televisions 5/5A/5B while some of the devices are computers 8/9. The televisions 5/5A/5B are typically controlled by a remote control 6/6A/6B. Also interfaced to the network 4 is a social network system 30, typically having a server 32 (or group of servers) and data storage 34 in which subscriber account data is stored, including, security credentials, lists of friends or buddies and groups of friends or buddies (e.g. a group of buddies that enjoy NASCAR racing).

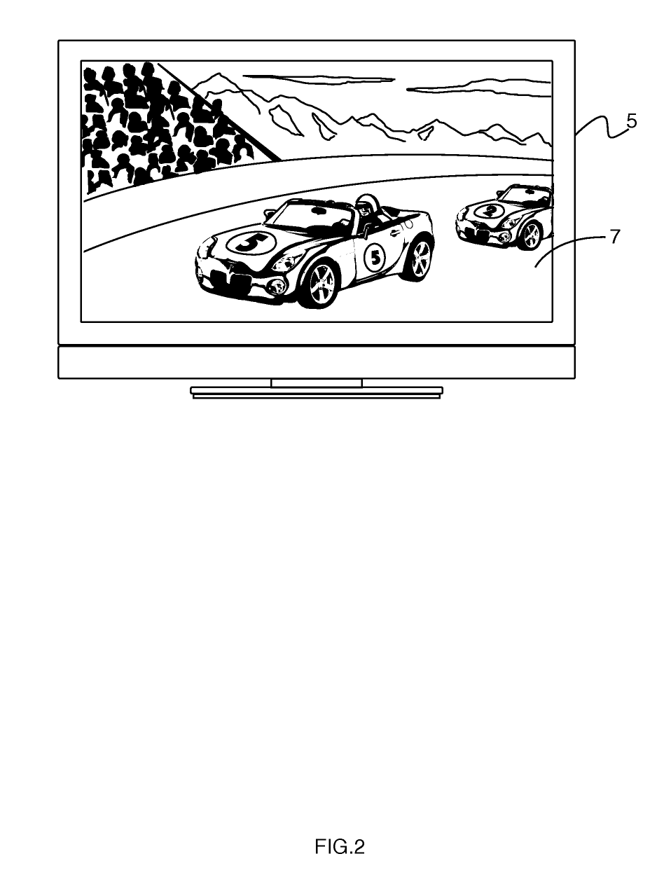

Referring to FIG. 2, a plan view of a typical television 5 showing a first content 7 being viewed by an originating user will be described. In this, the originating user is watching a first television program or content 7. In this example, the originating user is watching an automobile race.

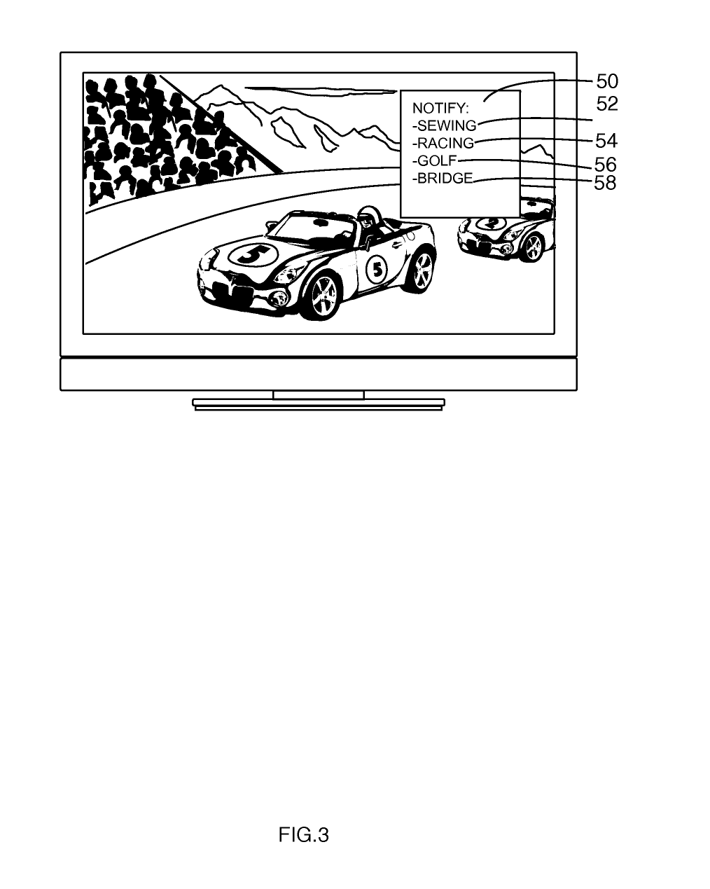

Referring to FIG. 3, a plan view of a typical television 5 showing the first content 7 and a pop-up selection 50 being viewed by the originating user will be described. In this, the originating user has operated their remote control 6 to initiate a menu 50 that is displayed over any part of the television program or content 7. The art of such menus is well known and includes, but is not limited to, overlays, pop-up messages, translucent messages, etc. In this example, the originating user is a member of social network groups related to sewing 52, racing 54, golf 56 and bridge 58. This is an exemplary list of groups and it is anticipated that any list of groups or individual subscribers/users of one or more disparate social networks be displayed in the menu 50. a similar menu 50 includes one or more identities of individual subscribers to one or more social networks selected by the originating user either by making those individual subscribers buddies or through a user interface of the television 5.

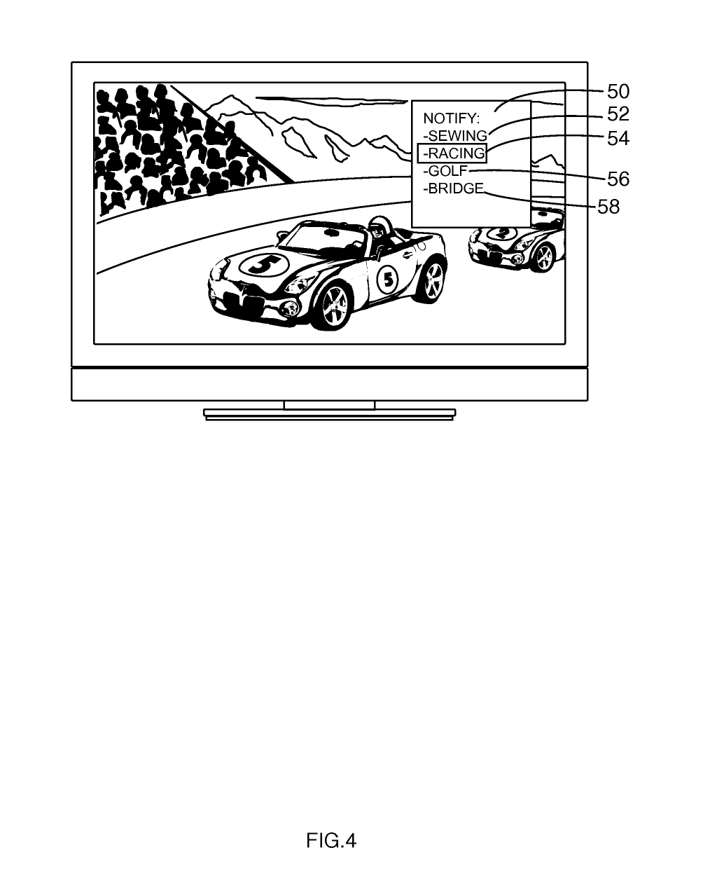

Referring to FIG. 4, a plan view of a typical television showing the first content 7 and a highlighted selection 54 as viewed by the originating user will be described. In this, the originating user has operated their remote control 6 to initiate a menu 50 that is displayed over any part of the television program or content 7 and highlighted the second selection 54 (racing) of the possible selections 52/54/56/58. It is well known in the industry to present a menu 50 and provide users with keys or input devices that navigate the menu 50 to select or highlight one particular item 54 within the menu and all known navigation methods are included here within, including but not limited to, arrow keys, joy sticks, roller balls, mice, sliders, touch pads, etc.

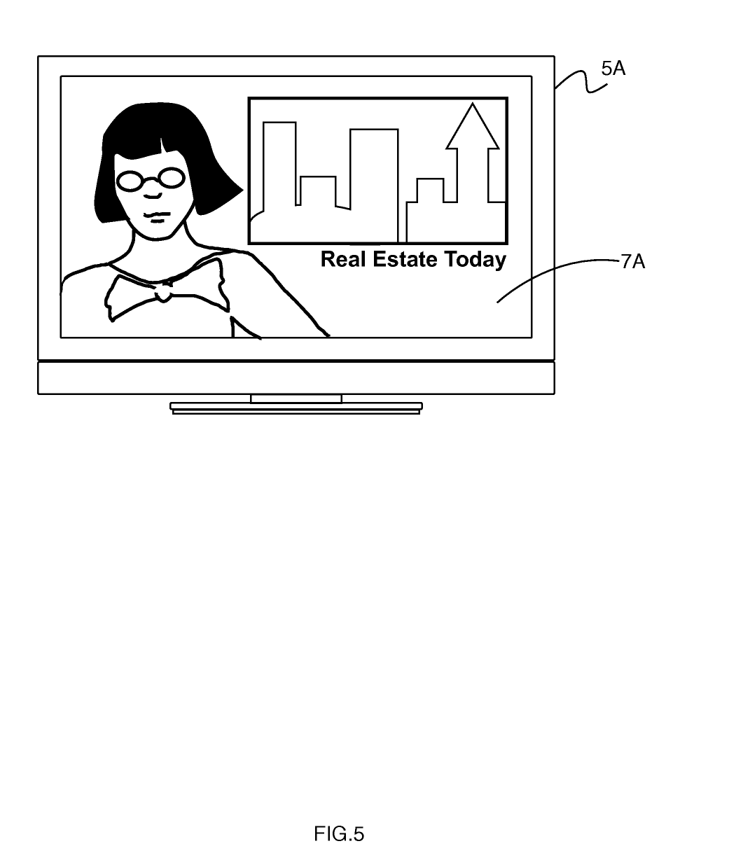

Referring to FIG. 5, a plan view of a typical television 5A showing a second content 7A being viewed by a receiving user will be described. In this, the receiving user is watching a second television program or content 7A. In this example, the receiving user is watching a news program.

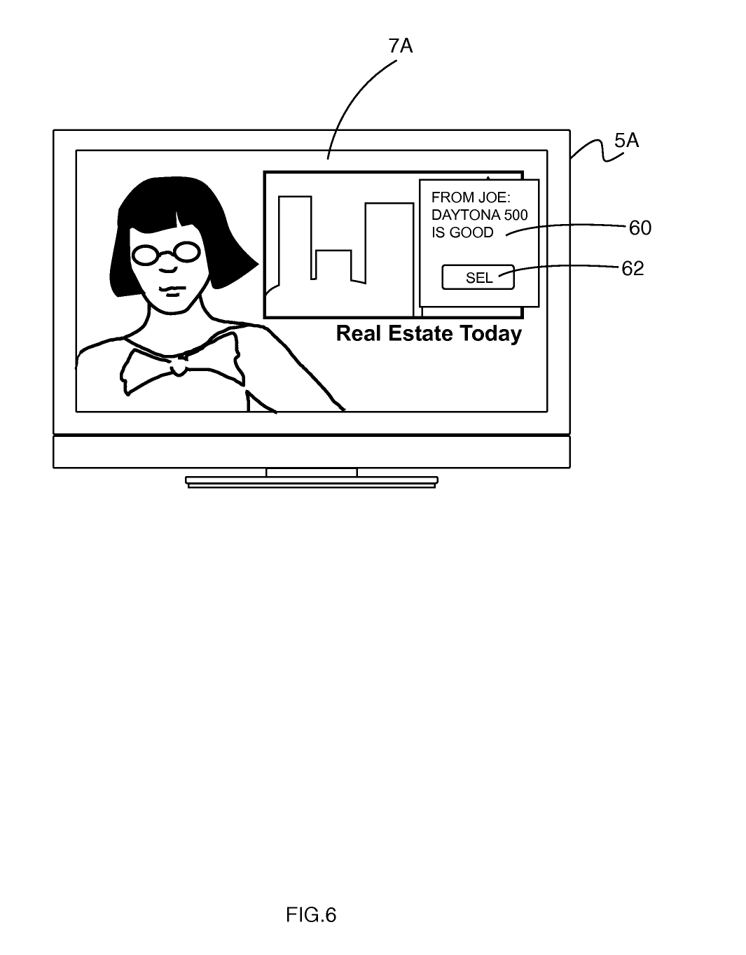

Referring to FIG. 6, a plan view of a typical television 5A showing the second content 7A and a pop-up message being viewed by the receiving user will be described. In this, the receiving user has received a signal from, for example, a social network to which the first and receiving user subscribe. The message 60 is from the originating user and the message 60 explains that the race that the originating user is watching is being televised. The message 60 indicates, in this exemplary user interface, that if the receiving user presses, for example, the select key 62, the television 5A will switch channels to show the race, instead of the news program. In some embodiments, the message 60 is displayed in a picture-in-picture (PIP) window and is either accepted, rejected or, in some embodiments, times out.

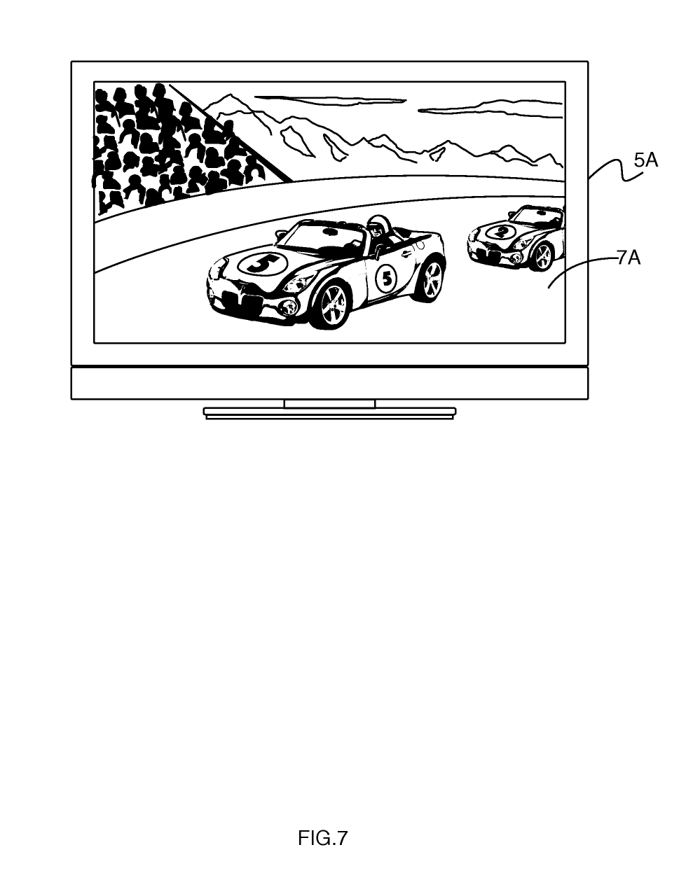

Referring to FIG. 7, a plan view of a typical television 5A showing the first content 7A now being viewed by the receiving user will be described. If the receiving user accepts the change by, for example, pressing the “Select” key or function, the television 5A changes channels to view the first content/program or race 7. As will be described, it is anticipated that the originating user and receiving user are served by the same or different content providers (e.g. cable, satellite, fiber, etc). In situations in which the originating user and receiving user are served by different content providers, it is anticipated that, in some situations, the first content 7 (e.g. race 7) is on a different channel or station and that a translation is performed using, for example, the title of the content 7 and a program guide.

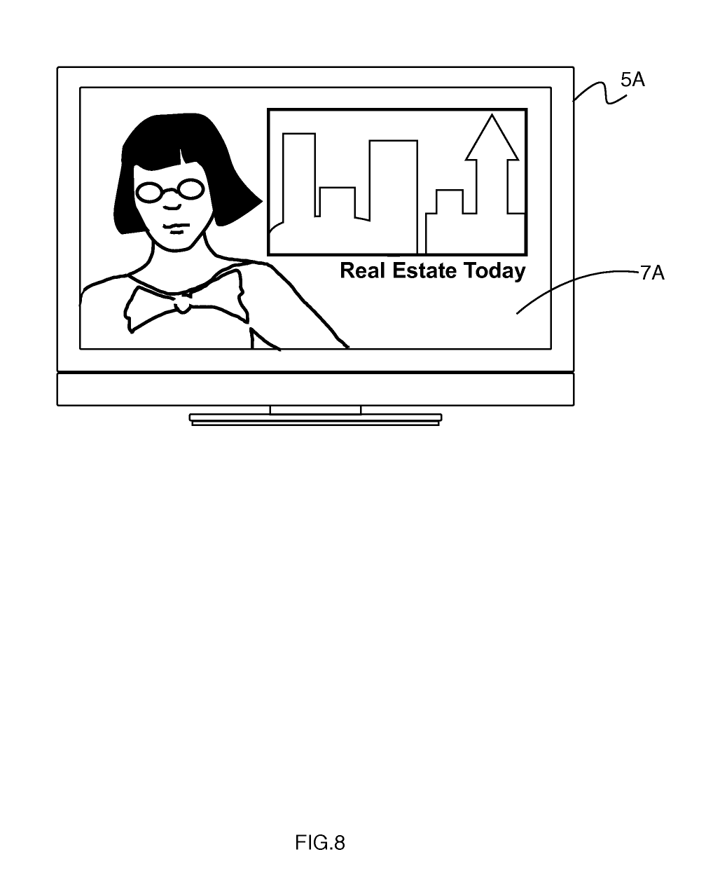

Referring to FIG. 8, a plan view of a typical television 5A showing the second content 7A still being viewed by the receiving user will be described. In this, the receiving user has either ignored the message from the originating user and the message was erased after a period of time of the receiving user pressed a different key or function (e.g. “Exit”) to signal the television 5A that they do not want to change programs and the content 7A already being watched continues.

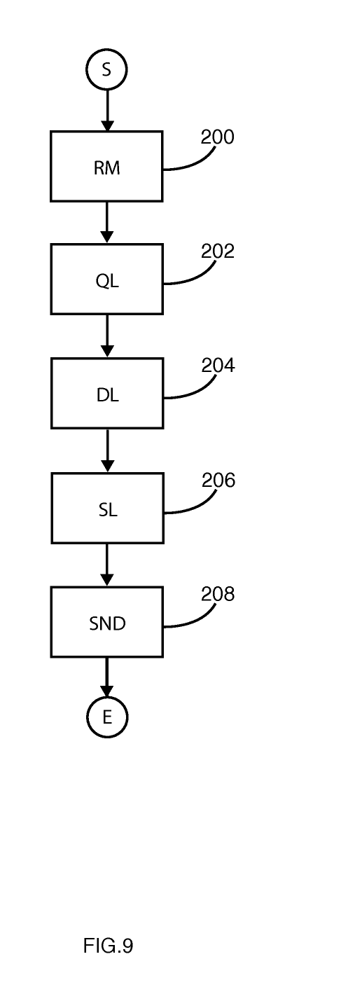

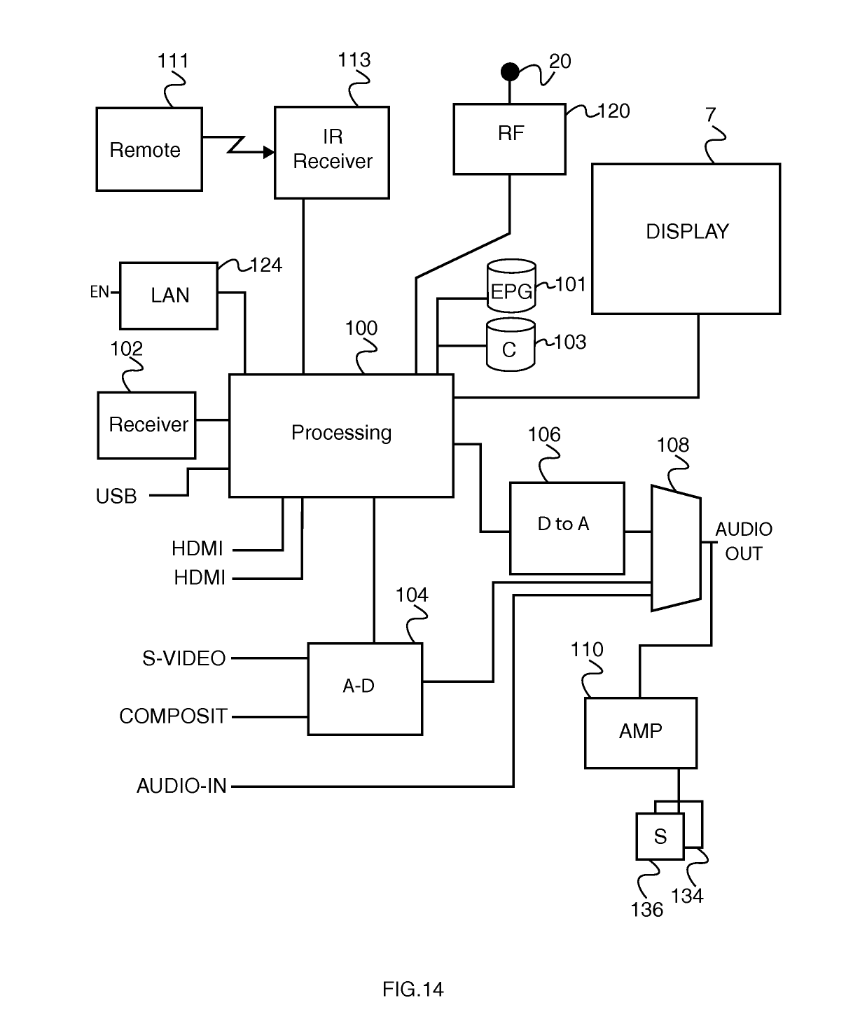

Referring to FIG. 9, a first flow chart operating on a processor within the typical television 5 will be described. Many different program flows are anticipated, this being one example. Action begins when, for example, the originating user is accessing content 7 (e.g. a television program, web content, downloaded video, etc). If that content is, say, interesting and the user wants to share it with a friend, networking group, or list of friends, the originating user signals their device 200 to present a menu 50. For example, the user presses a key on a remote control 6 and a menu 50 is presented on a television 5. In this example, a processing element 100 (see FIG. 14) of the television 5 accesses 202 a list of friends and/or groups and displays 204 the list as, for example, the menu 50. The user then selects 206 one or more entries from the list by, for example, navigating to that list using the remote control 6 and pressing a select key on the remote control 6. Responsive to the selection, the processing element 100 transmits 208 an information packet to the server 32 of, for example, the social network 30. Note that it is anticipated that in some situations the list of friends and/or groups exceeds the display space capabilities of the device/television 5 (e.g. an originating user has 100 buddies) and well known scrolling capabilities are provided to select 206 to one or more entries from the list.

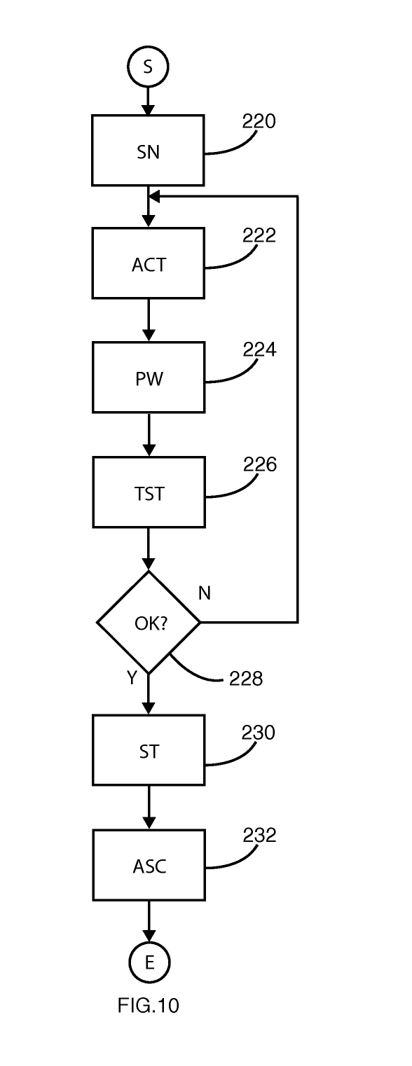

Referring to FIG. 10, a second flow chart operating on the processor within the typical television 5 will be described. This exemplary process is run to provide access to the television 5 by the server 32 (e.g. social network 30). The first step of this exemplary process is to identify 220 the system to be accessed (e.g. Plaxo, Facebook, Linkedln, etc). For example, a list of possible cooperating systems is presented and the user selects one on the list, or a keyboard is presented and the user enters a web address for the network of choice. Next, the user enters an account name or user name 222 and a password 224 or other account access credentials, for example on a keyboard of a remote or a displayed keyboard on the television 5. The password and account information are used to test access 226. If access is not allowed, the above steps are repeated until the proper user identity and access information are provided and access is allowed at which time the credentials are stored 230 local to the processor 100 (e.g. in local storage 103 as in FIG. 14) and an address of the device/television 5 (e.g. URL) is conveyed to the server 32. At this point, the television 5 is now known to the system (e.g. social network 30) and social networking features described are accessible.

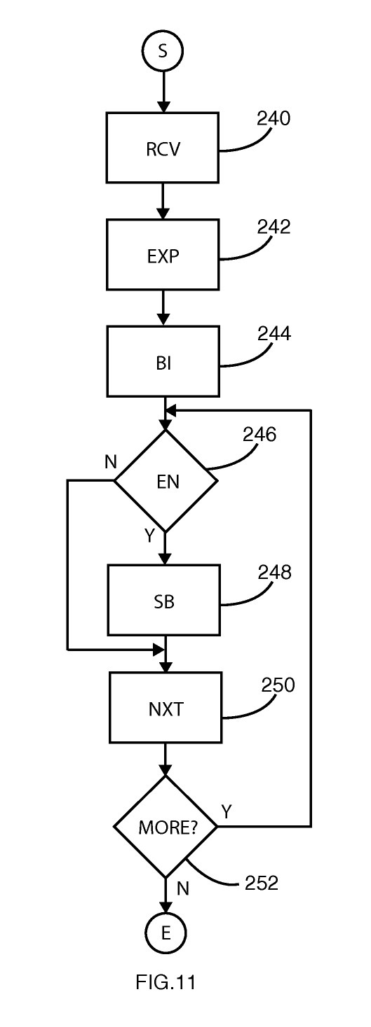

Referring to FIG. 11, a first flow chart operating on, for example, a server 32 of a social network 30 will be described. The server 32 receives 240 the packet of information from the television 5 and expands 242 any groups into a list of users then accesses a first receiving user 244. If the receiving user has enabled this activity 246 (e.g. has an address or URL of a device associated with their account as in FIG. 10), the server 32 sends a request packet 248 to that device/television. The request packet contains, for example, an identification of the originating user and an identification of the action (e.g. watch FOX for the race). In some embodiments, the request packet contains a channel, address, URL, or other identifying information to direct the receiving user to the content. In some embodiments, the request packet contains a title or description of the program and the receiving user or receiving device determines the proper channel, URL, station, etc, from the content.

A next receiving user on the list is accessed 250 and if more receiving users are on the list 252, the prior three steps 246/248/250 are repeated.

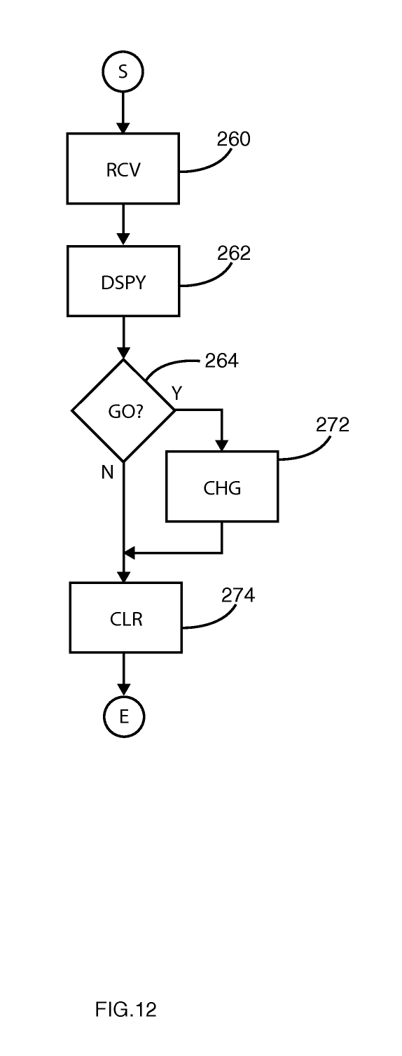

Referring to FIG. 12, a third flow chart operating on the processor 100 within the typical television 5 will be described. In this, the device/television 5 of the receiving user receives 260 the request packet from the server 32. The processor 100 displays 262 a message 60 including some or all of the information from the request packet 60 (see FIG. 6) and waits for a response from the receiving user. If the response is to go to that content 264, the processor 100 accesses the content 272. Once a response is made (e.g. to go to the content or ignore the message) or a time period elapses, the message 60 is cleared 274.

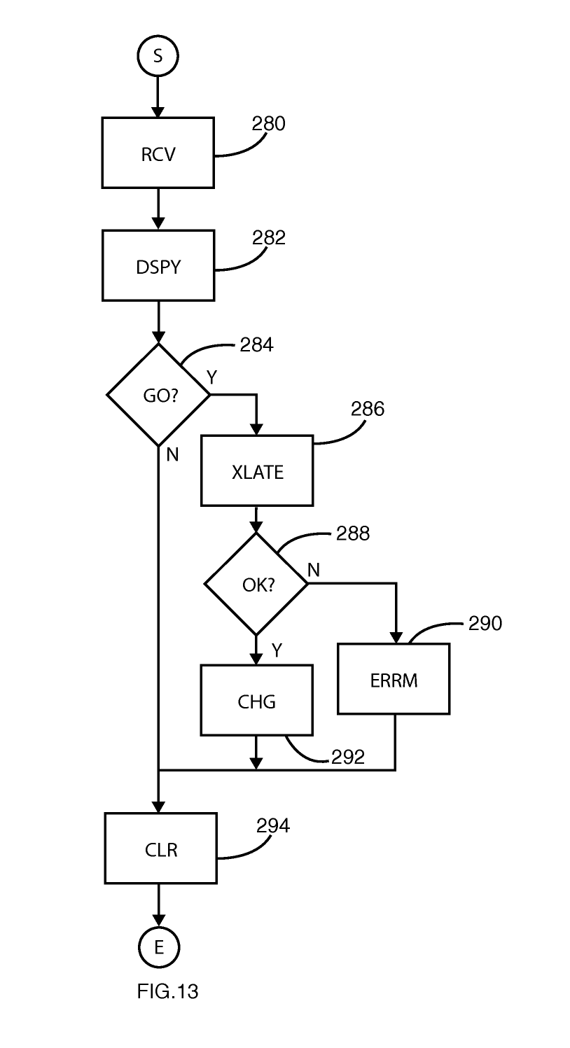

Referring to FIG. 13, a fourth flow chart operating on the processor 100 within the typical television 5 will be described. In this, the device/television 5 of the receiving user receives 280 the request packet from the server 32. The processor 100 displays 282 a message 60 including the information from the request packet (see FIG. 6) and waits for a response from the receiving user. If the response is to go to that content 284, the processor 100 translates 286 some of the information in the request packet into a local station or address. For example, the translation 286 is a search of a local electronic program guide 101 (see FIG. 14) for a name of a content or program contained in the request packet. If the translation is successful 288 (e.g. the program is available from the receiving user's service provider) accesses the content 292 is made. If translation is not successful 288, an error message is displayed 290 (e.g. “This program is not available from DISH network”). Once a response is made (e.g. to go to the content or ignore the message) or a time period elapses, the message 60 is cleared 294.

Referring to FIG. 14, a schematic view of an exemplary television will be described. This figure is intended as a representative schematic of a typical monitor/television 5 and in practice, some elements are not present in some monitors/televisions 5 and/or additional elements are present in some monitors/televisions 5 as known in the industry. In this example, a display panel 7 for content is connected to a processing element 100. The display panel 7 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High Definition Multimedia Interface (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element controls the display of the video on the display panel 7.

Audio emanates from either the broadcast receiver 102, the legacy source (e.g., S-Video) or a discrete analog audio input (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers it to internal speakers 134/136.

The processing element 100 accepts commands from a remote control 6/6A/6B/111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way from the remote 111 to the receiver 113 or two way.

In this exemplary television, the processing element 100 has local, persistent storage (e.g. flash memory, hard disk, etc) for storing and accessing, for example, an electronic program guide 101 and user information 103 such as social networking identification and access credentials.

In some embodiments, the television 5 connects to networks such as the Internet 4 through a wireless network interface 120 having an antenna 20. In some embodiments, the television connects to the Internet 4 through a local area network using a local area network adapter 124 for connecting to, for example, an Ethernet local area network or a power line local area network, as known in the industry.

Equivalent elements can be substituted for the ones set forth above such that they perform in substantially the same manner in substantially the same way for achieving substantially the same result.

It is believed that the system and method and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A social network system comprising:
a network;
a plurality of televisions, each of the televisions having a processor, each processor interfaced to the network;
a social network system, the social network system having a server, the server interfaced to the network;
a means for registering each of the televisions with the social network;
a means for signaling a first television of the televisions to initiate a social network function, responsive to means for signaling, the first television of the televisions sending an information packet over the network to the server;
a means for distributing a request packet from the social network to one or more of the televisions over the network; and
at the one or more of the televisions, a means for receiving the request packet, a means for displaying information from the request packet and a means for changing a content shown on the one or more of the televisions based on viewer approval.

2. The social network system of claim 1, wherein the means for signaling is a remote control, the remote control sending a command to the first television.

3. The social network system of claim 1, wherein the means for changing the content changes the content after the viewer approves using a remote control, the remote control sending a command to the television of the one or more of the televisions associated with the viewer.

4. The social network system of claim 1, wherein the content is a broadcast program.

5. The social network system of claim 1, wherein the means for changing the content includes a means for translating from an identifier within the request packet into a channel associated with the content.

6. The social network system of claim 5, wherein the means for translating from an identifier within the request packet into the channel associated with the content uses an electronic program guide stored locally to the television.

7. The social network system of claim 5, wherein the means for signaling the first television includes displaying a menu of subscribers of the social network.

8. The social network system of claim 1, wherein the means for signaling the first television includes displaying a menu of groups of subscribers of the social network.

9. A method of providing social network features to a television, the method comprising:
providing a network and a plurality of televisions, each of the televisions having a processor, each processor interfaced to the network;
providing a social network system, the social network system having a server, the server interfaced to the network;
registering each of the televisions with the social network;
signaling a first television of the televisions to initiate a social network function;
responsive to the signaling, the first television of the televisions sending an information packet over the network to the server;
the server distributing a request packet to one or more of the televisions over the network; and
at the one or more of the televisions, receiving the request packet, displaying information from the request packet and changing a content shown on the one or more of the televisions based on viewer approval.

10. The method of claim 9, wherein the signaling is initiated by a remote control, the remote control sending a command to the first television.

11. The method of claim 9, wherein the changing the content shown changes the content after the viewer approves using a remote control, the remote control sending a command to the television of the one or more of the televisions associated with the viewer.

12. The method of claim 9, wherein the content is a broadcast program.

13. The method of claim 9, wherein changing the content includes translating from an identifier within the request packet into a channel associated with the content.

14. The method of claim 13, wherein translating from an identifier within the request packet into the channel associated with the content uses an electronic program guide stored locally to the television.

15. The method of claim 9, wherein the signaling the first television includes displaying a menu of subscribers of the social network.

16. The method of claim 9, wherein the means for signaling the first television includes displaying a menu of groups of subscribers of the social network.

17. The method of claim 9, wherein registering each of the televisions with the social network includes inputting at least a user name and password for the social network and saving the user name and password in storage local to the first television.

18. A system for providing social network features to a television, the system comprising:
a network, a first television and a second television, each of the televisions having a processor, each processor interfaced to the network;
a social network system, the social network system having a server, the server interfaced to the network;
software running on each of the processors registers each of the televisions with the social network;
software running on the processor of the first television initiates a social network function responsive to a command from a remote control associated with the first television by sending an information packet over the network to the server;
software running on the server receives the information packet and, responsive to the information packet, distributes a request packet over the network to one or more televisions, including the second television; and
software running on the processor of the second television receives the request packet, displays information from the request packet, reads a viewer's command from a remote control associated with the second television, and changes a content shown on the second televisions based on approval of the viewer.

19. The system of claim 18, wherein the changing the content shown changes the content after the viewer approves using a remote control, the remote control sending a command to the television of the one or more of the televisions associated with the viewer.

20. The system of claim 18, wherein the content is a broadcast program.

21. The system of claim 18, wherein changing the content includes translating from an identifier within the request packet into a channel associated with the content.

22. The system of claim 21, wherein translating from an identifier within the request packet into the channel associated with the content uses an electronic program guide stored locally to the television.

23. The system of claim 18, wherein the signaling the first television includes displaying a menu of subscribers of the social network.

24. The system of claim 18, wherein the means for signaling the first television includes displaying a menu of groups of subscribers of the social network.

25. The system of claim 18, wherein registering each of the televisions with the social network includes inputting at least a user name and password for the social network and saving the user name and password in storage local to the first television.
